(19) United States
(12) Patent Application Publication
(10) Pub. No.: US 2024/0255910 A1
(43) Pub. Date: Aug. 1, 2024

(54) SYSTEM AND METHOD FOR DEVICE CONTROL, AND RELATED APPARATUSES

(71) Applicant: FIREFLY TECHNOLOGY CO., LIMITED, Guangzhou, Guangdong (CN)

(72) Inventors: Zhi LI, Guangzhou, Guangdong (CN); Feng PENG, Guangzhou, Guangdong (CN)

(73) Assignee: FIREFLY TECHNOLOGY CO., LIMITED, Guangzhou, Guangdong (CN)

(21) Appl. No.: 18/019,895

(22) PCT Filed: Jul. 28, 2022
(86) PCT No.: PCT/CN2022/108420

§ 371 Date: Feb. 6, 2023

(51) Int. Cl. G05B 19/042

(52) U.S. Cl. CPC G05B 19/0423; G05B 2219/25257

(57) ABSTRACT

A system for device control, a method for device control, and related apparatuses are provided. The system for device control includes a power supply, a controller, at least one load-power distribution module, and multiple loads corresponding to each of the at least one load-power distribution module. The power supply is configured for powering. The controller is configured to generate a control signal. The at least one load-power distribution module is configured to receive the control signal to control multiple loads of a load-power distribution module corresponding to the control signal to work, where the power of each of the multiple loads is less than or equal to a total output power of the power supply.

### CROSS-REFERENCE TO RELATED APPLICATION(S)

This application is a National Stage of International Application No. PCT/CN2022/108420, field Jul. 28, 2022, the entire disclosure of which is hereby incorporated by reference.

### TECHNICAL FIELD

This application relates to the field of electronic technology or communication technology, and particularly to a system and method for device control, and related apparatuses.

### BACKGROUND

In practice, in a state of rated power consumption, power consumption of a load is the same as the rated power consumption. When multiple loads are required for cascading, the rated power consumption cannot meet the demand. Taking release of a fire fighting cylinder as an example, only one fire fighting cylinder (load) can be released at a time, however, the requirement for releasing two fire fighting cylinders (loads) at a time cannot be met. Therefore, how to improve a working efficiency of the loads when there are multiple loads has become an urgent problem to-be-solved.

### SUMMARY

In a first aspect, implementations of the disclosure provide a system for device control. The system for device control includes a power supply, a controller, at least one load-power distribution module, and a plurality of loads corresponding to each of the at least one load-power distribution module. The power supply is configured for powering. The controller is configured to generate a control signal. The at least one load-power distribution module is configured to receive the control signal to control a plurality of loads of a load-power distribution module corresponding to the control signal to work, where a power of each of the plurality of loads is less than or equal to a total output power of the power supply.

In a second aspect, implementations of the disclosure provide a method for device control. The method is applied to a system for device control including a power supply for powering, a controller, at least one load-power distribution module, and a plurality of loads corresponding to each of the at least one load-power distribution module. The method includes the following. A control signal is generated with the controller. In response to the control signal, a plurality of loads of a load-power distribution module corresponding to the control signal are controlled, with the load-power distribution module corresponding to the control signal, to work, where a power of each of the plurality of loads is less than or equal to a total output power of the power supply.

In a third aspect, implementations of the disclosure provide a control device. The control device includes a processor and a memory. The memory is coupled with the processor, and stores computer programs which are operable with the processor to execute the operations of the method in the second aspect.

In a fourth aspect, implementations of the disclosure provide a non-transitory computer-readable storage medium. The non-transitory computer-readable storage medium stores computer programs which, when executed by a processor, cause the processor to carry out actions, comprising: generating a control signal; and controlling a plurality of loads of a load-power distribution module corresponding to the control signal to work in response to the control signal, a power of each of the plurality of loads being less than or equal to a total output power of a power supply, a system for device control comprising at least one load-power distribution module, a plurality of loads corresponding to each of the at least one load-power distribution module, and the power supply.

### BRIEF DESCRIPTION OF THE DRAWINGS

In order to describe technical solutions of implementations of the disclosure or the related art more clearly, the following will give a brief description of accompanying drawings used for describing the implementations or the related art. Apparently, accompanying drawings described below are merely some implementations. Those of ordinary skill in the art can also obtain other accompanying drawings based on the accompanying drawings described below without creative efforts.

FIG. 1 is a schematic structural diagram illustrating a system for device control provided in implementations of the disclosure.

FIG. 2 is a schematic structural diagram illustrating another system for device control provided in implementations of the disclosure.

FIG. 3 is a schematic structural diagram illustrating another system for device control provided in implementations of the disclosure.

FIG. 4 is a schematic diagram illustrating a working timing of a control signal of a system for device control provided in implementations of the disclosure.

FIG. 5 is a schematic flowchart illustrating a method for device control provided in implementations of the disclosure.

FIG. 6 is a schematic structural diagram illustrating a control device provided in implementations of the disclosure.

FIG. 7 is a block diagram illustrating functional units of an apparatus for device control provided in implementations of the disclosure.

### DETAILED DESCRIPTION

The terms “first”, “second”, and the like used in the specification, the claims, and the accompany drawings of the disclosure are used to distinguish different objects rather than describe a particular order. The terms “include”, “comprise”, and “have” as well as variations thereof are intended to cover non-exclusive inclusion. For example, a process, method, system, product, or device including a series of steps or units is not limited to the listed steps or units, on the contrary, it can optionally include other steps or units that are not listed; alternatively, other steps or units inherent to the process, method, product, or device can be included either.

The term “implementation” referred to herein means that particular features, structures, or properties described in conjunction with the implementations may be defined in at least one implementation of the disclosure. The phrase “implementation” appearing in various places in the specification does not necessarily refer to the same implementation or an independent/alternative implementation that is mutually exclusive with other implementations. Those skilled in the art will understand expressly and implicitly that an implementation described herein may be combined with other implementations.

In order for those skilled in the art to better understand technical solutions of the disclosure, technical solutions of implementations of the disclosure will be depicted clearly and completely below with reference to accompanying drawings in the implementations of the disclosure. Apparently, implementations described hereinafter are merely some implementations, rather than all implementations, of the disclosure. All other implementations obtained by those of ordinary skill in the art based on the implementations of the disclosure without creative efforts shall fall within the protection scope of the disclosure.

The control device of implementations of the disclosure may include various handheld devices with a wireless communication functions (e.g., smart phones, tablet computers), on-board devices, wearable devices (e.g., smart watches, smart bracelets, wireless earphones, augmented reality/virtual reality devices, smart glasses), computing devices or other processing devices connected to a wireless modem, and various forms of user equipment (UE), mobile stations (MS), terminal devices, etc. For convenience of description, the devices mentioned above are collectively referred to as control devices. The control device may include the controller of the system for device control. The load may be a module that uses a power of a load-power distribution module to work, and the module may include at least one of a fire fighting cylinder, a pick machine, etc., which is not limited herein.

Hereinafter, implementations of the disclosure will be depicted in detail.

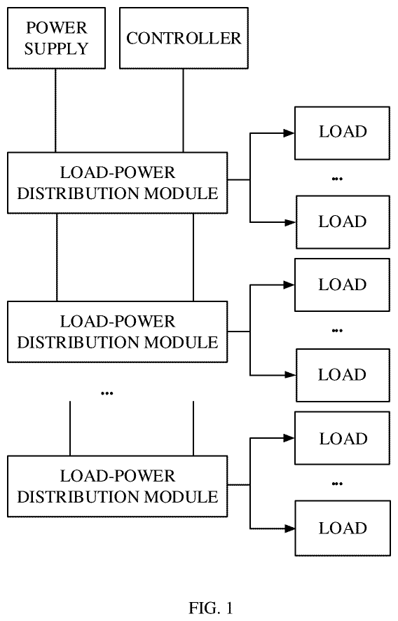

Referring to FIG. 1, FIG. 1 is a schematic structural diagram illustrating a system for device control provided in implementations of the disclosure. As illustrated in FIG. 1, the system for device control includes a power supply, a controller, at least one load-power distribution module, and multiple loads corresponding to each of the at least one load-power distribution module. The power supply is configured for powering. The controller is configured to generate a control signal. The at least one load-power distribution module is configured to receive the control signal to control multiple loads of a load-power distribution module corresponding to the control signal to work, where a power of each of the multiple loads is less than or equal to a total output power of the power supply.

The power supply is electrically connected with the controller, each of the at least one load-power distribution module, and each load. Each of the at least one load-power distribution module is connected with multiple corresponding loads. Specifically, each load-power distribution module is connected in parallel with a load(s) corresponding to the load-power distribution module, thereby realizing uniform or non-uniform distribution of power, that is, ensuring that a power(s) of a load(s) corresponding to the load-power distribution module in a working state is equal to or less than the total output power of the power supply, to ensure a working efficiency of the loads, in other words, to ensure that multiple loads work simultaneously.

In a specific implementation, the power supply is configured for powering, and the controller is configured to generate a control signal. The control signal may be set by a user or by default. For instance, the user may input different control instructions, and the different control instructions can be used to generate different control signals. The control signal is used to control one or more of the at least one load-power distribution module to work. As an example, the control signal is used to control any of the at least one load-power distribution module to work, specifically, controlling, through the load-power distribution module, multiple loads corresponding to the load-power distribution module to work. As another example, the control signal is used to control two of the at least one load-power distribution module to work, specifically, controlling, through the two load-power distribution modules, multiple loads corresponding to the two load-power distribution modules to work simultaneously. Alternatively, the control signal is used to control two of the at least one load-power distribution module to work, specifically, controlling, through one load-power distribution module (hereinafter, “first load-power distribution module”) in the two of the at least one load-power distribution module, multiple loads corresponding to the first load-power distribution module to work simultaneously, and controlling, through the other load-power distribution module (hereinafter, “second load-power distribution module”) in the two of the at least one load-power distribution module, loads corresponding to the second load-power distribution module to work once the first load-power distribution module finishes work.

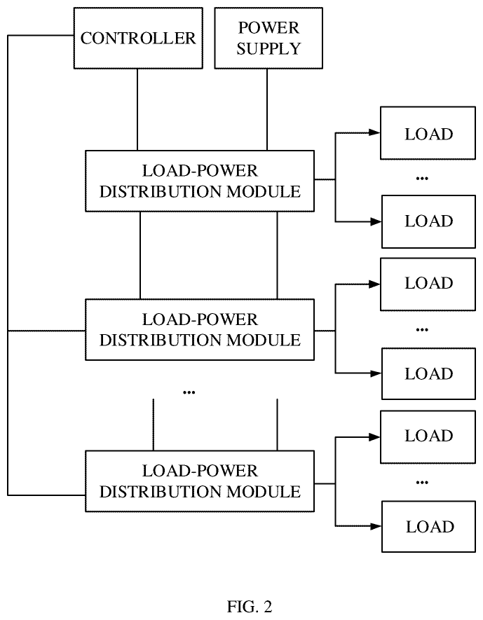

In a specific implementation, as illustrated in FIG. 2, the controller is connected with each of the at least one load-power distribution module, so that two or more of the at least one load-power distribution module can be controlled to work simultaneously, thus further improving the work efficiency of the loads. Alternatively, the controller is connected with two or more of the at least one load-power distribution module, so that loads corresponding to the two or more of the at least one load-power distribution module can be controlled to work simultaneously, thereby further improving the work efficiency of the loads.

The number of loads corresponding to each load-power distribution module may be the same or different. For example, the number of loads corresponding to load-power distribution module 1 is 2, the number of loads corresponding to load-power distribution module 2 is 3, the number of loads corresponding to load-power distribution module 3 is 4, and so on.

In implementations of the disclosure, the number of loads of each load-power distribution module may be increased or decreased according to actual needs, which can ensure working flexibility of the load-power distribution module. Loads may be the same or different. Different loads may perform the same task or different tasks. The number of load-power distribution modules may also be increased or decreased according to actual needs, which can ensure cascade flexibility of the system for device control.

Implementations of the disclosure can be used to solve a problem that in a state of rated power consumption, power consumption of a load is the same as the rated power consumption, but the rated power consumption cannot meet the demand when multiple loads are required for cascading, whereas in the disclosure, the load-power distribution module is connected in parallel with multiple loads, so that these loads are the same in powers, thereby ensuring that each of these loads works normally.

In a possible implementation, the control signal is configured to control a target load-power distribution module, and the target load-power distribution module is any of the at least one load-power distribution module. The target load-power distribution module is configured to control multiple loads corresponding to the target load-power distribution module to work simultaneously, in response to the control signal.

The target load-power distribution module may be default or specified by a user, and the target load-power distribution module is any one of at least one load-power distribution module.

In a specific application, the control signal is configured to control the target load-power distribution module, and the target load-power distribution module is configured to control multiple loads corresponding to the target load-power distribution module to work simultaneously in response to the control signal, that is, a specified load-power distribution module is controlled to work, to control loads corresponding to the specified load-power distribution module to work simultaneously.

In a scenario where continuous powering is not required, in implementations of the disclosure, energy saving is realized by using a pulse circuit principle and using a circuit principle that single rated power consumption corresponds to multiple loads, that is, the control signal may be a pulse signal, which can be realized through a pulse circuit. For example, when the pulse signal is at high level, multiple loads corresponding to the target load-power distribution module are controlled to work simultaneously; when the pulse signal is at low level, the target load-power distribution module is in a dormant state, that is, multiple loads corresponding to the target load-power distribution module are not controlled to work simultaneously. As such, power consumption of the system can be reduced and service life can be prolonged.

In a possible implementation, the at least one load-power distribution module configured to receive the control signal to control the multiple loads of the load-power distribution module corresponding to the control signal to work is specifically configured to: control a load-power distribution module i to stop working when the load-power distribution module i controls, for a preset duration, a load corresponding the load-power distribution module i to work, where the load-power distribution module i is one of the at least one load-power distribution module; determine a next load-power distribution module of the load-power distribution module i; and control, with the next load-power distribution module, multiple loads corresponding to the next load-power distribution module to work simultaneously.

The preset duration may be set in advance or by default. The preset duration may be implemented by a timer, each load-power distribution module may correspond to a timer, and timing durations of different timers may be the same or different.

In implementations of the disclosure, different load-power distribution modules can be electrically connected to each other in a cascade manner, in this situation, a load-power distribution module with a delay function can be provided to meet requirements, so that loads at each stage can be instantaneously released at the rated power consumption.

In a specific implementation, taking the load-power distribution module i as an example, the load-power distribution module i is one of the at least one load-power distribution module, when the load-power distribution module i controls, for a preset duration, a load(s) corresponding to the load-power distribution module i to work, the load-power distribution module i is controlled to stop working, where the load-power distribution module i is one of the at least one load-power distribution module; a next load-power distribution module of the load-power distribution module i is determined; and multiple loads corresponding to the next load-power distribution module are controlled to work simultaneously through the next load-power distribution module. As such, sequential powering can be realized during powering, while energy saving can also be realized.

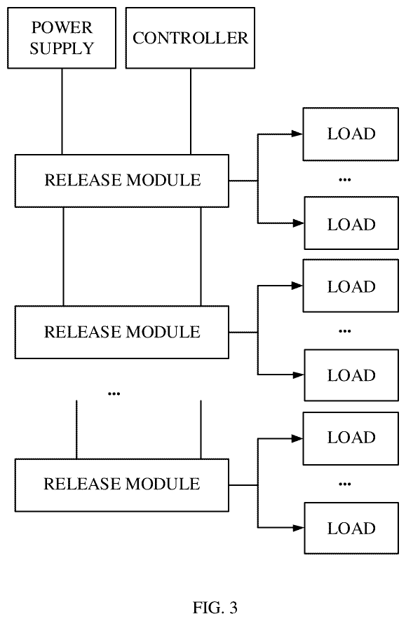

The load-power distribution module, for example, is a release module, that is, the system for device control is applicable to release of a fire fighting cylinder. As illustrated in FIG. 3, the system for device control includes a power supply, a controller, at least one release module, and multiple loads corresponding to each release module. Each release module is connected in parallel with corresponding multiple loads.

Different release modules can form a cascade structure, and a working sequence of different stages of release modules can be guaranteed through timers, which can ensure that the release modules work orderly.

As an example, an output voltage for powering is U and an output current is I, and accordingly, an output power is W=UI. If a desired power of a load (load 1) is also W, in this situation, the requirement for a power of a second load (load 2) cannot be met, that is, a desired power of the two loads is 2*W when the two loads are cascaded. In implementations of the disclosure, the requirement for the power of the second load (load 2) is met without changing rated power consumption output for powering. As such, the two loads can be guaranteed to work simultaneously, thereby improving a working efficiency of the loads.

In a possible implementation, the load-power distribution module i includes a timer, and the timer is configured to set the preset duration.

The load-power distribution module i may include a timer for setting the preset duration. The preset duration is related to the load, and required preset durations may be different for different loads.

In a possible implementation, the controller is connected with the multiple loads. The controller is configured to obtain state parameters of the multiple loads, and generate the control signal according to the state parameters.

In a specific implementation, the controller is connected with multiple loads, to monitor a state(s) of the load(s) and obtain the state parameter(s) of the load(s). State parameters of different loads may be different. Taking a fire fighting cylinder as an example of the load, the state parameter may include at least one of temperature, pressure, gas volume, etc., which is not limited herein. Different state parameters reflect different safety levels of fire fighting cylinders, that is, if the safety level of the fire fighting cylinder exceeds a certain safety level, a control signal is triggered, and release of the fire fighting cylinder is controlled according to the control signal, thus ensuring safety of fire fighting cylinders.

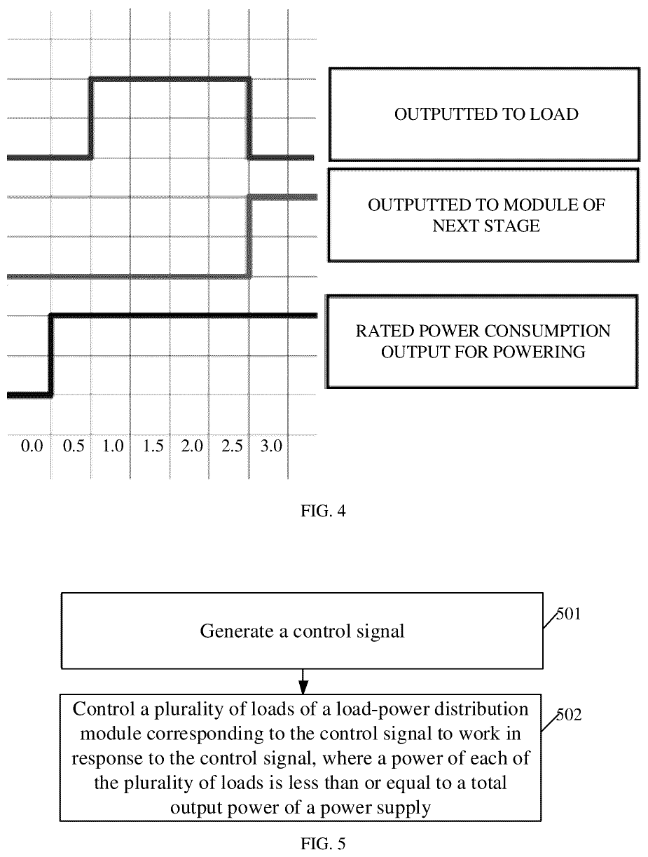

Further, as illustrated in FIG. 4, when a control signal of a current release module is at high level, the control signal is outputted to the load(s) to control the load to work. Conversely, when the control signal of the current release module is at low level, the control signal is outputted to a module of a next stage (a next release module), that is, when a control signal of the next release module is at high level, a load(s) of the next release module is controlled to work. Since the system for device control is always in a working state, a control signal corresponding to the rated power consumption output for powering is continuously at high level.

Exemplarily, the principle of implementations of the disclosure is not only applicable to release of fire-fighting gas cylinders, but also applicable to application of pick machines and other scenarios. For instance, different pick machines are regarded as loads and these pick machines are controlled to pick simultaneously, thereby improving a pick efficiency.

As can be seen, according to the system for device control of implementations of the disclosure, the system for device control includes the power supply, the controller, the at least one load-power distribution module, and the multiple loads corresponding to each load-power distribution module. The power supply is configured for powering. The controller is configured to generate the control signal. The at least one load-power distribution module is configured to receive the control signal to control the multiple loads of the load-power distribution module corresponding to the control signal to work, where the power of each load is less than or equal to the total output power of the power supply. The load-power distribution module is connected in parallel with multiple loads, so that the power of each of these loads can be equal to or less than the total output power of the power supply, which can ensure that each of these loads works normally, thereby improving a work efficiency of the loads when there are multiple loads.

Consistent with implementations with reference to FIG. 1, referring to FIG. 5, FIG. 5 is a schematic flowchart illustrating a method for device control provided in implementations of the disclosure. As illustrated in FIG. 5, the method for device control is applied to the system for device control illustrated in FIG. 1, and includes the following.

At 501, a control signal is generated.

At 502, in response to the control signal, multiple loads of a load-power distribution module corresponding to the control signal are controlled to work, where a power of each of the multiple loads is less than or equal to a total output power of the power supply.

In a possible implementation, the control signal is configured to control a target load-power distribution module, and the target load-power distribution module is any of the at least one load-power distribution module. The multiple loads of the load-power distribution module corresponding to the control signal are controlled to work (at 502) as follows. Multiple loads corresponding to the target load-power distribution module are controlled to work simultaneously.

In a possible implementation, the multiple loads of the load-power distribution module corresponding to the control signal are controlled to work (at 502) as follows. When a load-power distribution module i controls, for a preset duration, a load corresponding the load-power distribution module i to work, the load-power distribution module i is controlled to stop working, where the load-power distribution module i is one of the at least one load-power distribution module. A next load-power distribution module of the load-power distribution module i is determined. The next load-power distribution module controls multiple loads corresponding to the next load-power distribution module to work simultaneously.

In a possible implementation, the load-power distribution module i includes a timer, and the timer is configured to set the preset duration.

In a possible implementation, the controller is connected with the multiple loads, the method further includes: obtaining, with the controller, state parameters of the multiple loads; and generating the control signal according to the state parameters.

For details of each operation of the method for device control, reference may be made to corresponding description of the above system for device control, which will not be repeated herein.

As can be seen, the method for device control of implementations of the disclosure is applied to the system for device control. The system for device control includes the power supply, the controller, the at least one load-power distribution module, and the multiple loads corresponding to each load-power distribution module. The power supply is configured for powering. The controller is configured to generate the control signal. The at least one load-power distribution module is configured to receive the control signal to control the multiple loads of the load-power distribution module corresponding to the control signal to work, where the power of each load is less than or equal to the total output power of the power supply. The load-power distribution module is connected in parallel with multiple loads, so that the power of each of these loads can be equal to or less than the total output power of the power supply, which can ensure that each of these loads works normally, thereby improving a work efficiency of the loads when there are multiple loads.

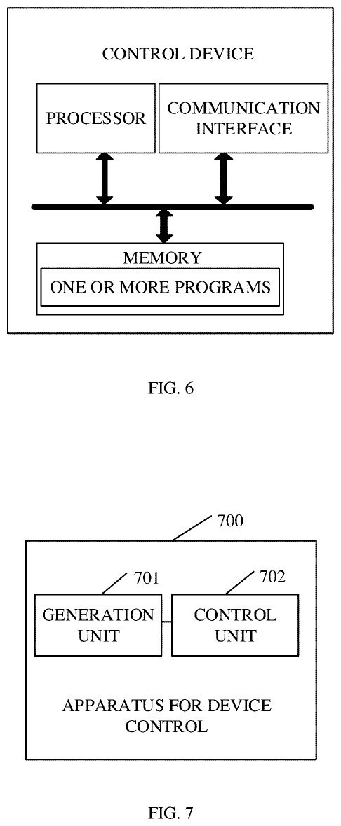

Consistent with the foregoing implementations, referring to FIG. 6, FIG. 6 is a schematic structural diagram illustrating a control device provided in implementations of the disclosure. As illustrated in FIG. 6, the control device includes a processor, a memory, a communication interface, and one or more programs. The one or more programs are stored in the memory and configured to be executed by the processor. In implementations of the disclosure, the control device is applied to the system for device control. The system for device control includes a power supply, a controller, at least one load-power distribution module, and multiple loads corresponding to each of the at least one load-power distribution module. The programs include instructions which are operable to execute the following operations. A control signal is generated. In response to the control signal, multiple loads of a load-power distribution module corresponding to the control signal are controlled to work, where a power of each of the multiple loads is less than or equal to a total output power of the power supply.

In a possible implementation, the control signal is configured to control a target load-power distribution module, and the target load-power distribution module is any of the at least one load-power distribution module. The instructions of the programs operable to execute controlling the multiple loads of the load-power distribution module corresponding to the control signal to work are operable to execute: controlling multiple loads corresponding to the target load-power distribution module to work simultaneously.

In a possible implementation, the instructions of the programs operable to execute controlling the multiple loads of the load-power distribution module corresponding to the control signal to work are operable to execute: controlling a load-power distribution module i to stop working when the load-power distribution module i controls, for a preset duration, a load corresponding the load-power distribution module i to work, where the load-power distribution module i is one of the at least one load-power distribution module; determining a next load-power distribution module of the load-power distribution module i; and controlling, with the next load-power distribution module, multiple loads corresponding to the next load-power distribution module to work simultaneously.

In a possible implementation, the load-power distribution module i includes a timer, and the timer is configured to set the preset duration.

In a possible implementation, the controller is connected with the multiple loads. The instructions of the programs are operable to execute: obtaining state parameters of the multiple loads, and generating the control signal according to the state parameters.

As can be seen, the control device of implementations of the disclosure is applied to the system for device control. The system for device control includes the power supply, the controller, the at least one load-power distribution module, and the multiple loads corresponding to each load-power distribution module. The power supply is configured for powering. The controller is configured to generate the control signal. The at least one load-power distribution module is configured to receive the control signal to control the multiple loads of the load-power distribution module corresponding to the control signal to work, where the power of each load is less than or equal to the total output power of the power supply. The load-power distribution module is connected in parallel with multiple loads, so that the power of each of these loads can be equal to or less than the total output power of the power supply, which can ensure that each of these loads works normally, thereby improving a work efficiency of the loads when there are multiple loads.

FIG. 7 is a block diagram illustrating functional units of an apparatus 700 for device control provided in implementations of the disclosure. The apparatus 700 is applied to the system for device control. The system for device control includes a power supply, a controller, at least one load-power distribution module, and multiple loads corresponding to each of the at least one load-power distribution module. The apparatus 700 includes a generation unit 701 and a control unit 702. The generation unit 701 is configured to generate a control signal. The control unit 702 is configured to control multiple loads of a load-power distribution module corresponding to the control signal to work in response to the control signal, where a power of each of the multiple loads is less than or equal to a total output power of the power supply.

In a possible implementation, the control signal is configured to control a target load-power distribution module, and the target load-power distribution module is any of the at least one load-power distribution module. The control unit 702 configured to control the multiple loads of the load-power distribution module corresponding to the control signal to work is specifically configured to: control multiple loads corresponding to the target load-power distribution module to work simultaneously.

In a possible implementation, the control unit 702 configured to control the multiple loads of the load-power distribution module corresponding to the control signal to work is specifically configured to: control a load-power distribution module i to stop working when the load-power distribution module i controls, for a preset duration, a load corresponding the load-power distribution module i to work, where the load-power distribution module i is one of the at least one load-power distribution module; determine a next load-power distribution module of the load-power distribution module i; and control, with the next load-power distribution module, multiple loads corresponding to the next load-power distribution module to work simultaneously.

In a possible implementation, the load-power distribution module i includes a timer, and the timer is configured to set the preset duration.

In a possible implementation, the controller is connected with the multiple loads. The apparatus 700 is further configured to: obtain state parameters of the multiple loads through the controller, and generate the control signal according to the state parameters.

As can be seen, the apparatus for device control of implementations of the disclosure is applied to the system for device control, the system for device control includes the power supply, the controller, the at least one load-power distribution module, and the multiple loads corresponding to each load-power distribution module. The power supply is configured for powering. The controller is configured to generate the control signal. The at least one load-power distribution module is configured to receive the control signal to control the multiple loads of the load-power distribution module corresponding to the control signal to work, where the power of each load is less than or equal to the total output power of the power supply. The load-power distribution module is connected in parallel with multiple loads, so that the power of each of these loads can be equal to or less than the total output power of the power supply, which can ensure that each of these loads works normally, thereby improving a work efficiency of the loads when there are multiple loads.

It can be understood that, a function of each program module of the apparatus for device control of the disclosure can be implemented according to the method in the foregoing method implementations, for the specific implementation process, reference may be made to relevant description of the foregoing method implementations, which will not be repeated herein.

Implementations of the disclosure further provide a computer-readable storage medium. The computer-readable storage medium stores computer programs for electronic data interchange. The computer programs are operable with a computer to execute all or part of the operations of the method of the foregoing method implementations. The computer includes a control device.

Implementations of the disclosure further provide a computer program product. The computer program product includes a non-transitory computer-readable storage medium storing computer programs. The computer programs are operable with a computer to execute all or part of the operations of the method of the foregoing method implementations. The computer program product may be a software installation package, and the computer includes a control device.

It is to be noted that, for the sake of simplicity, the foregoing method implementations are described as a series of action combinations, however, it will be appreciated by those skilled in the art that the disclosure is not limited by the sequence of actions described. That is because that, according to the disclosure, certain steps or operations may be performed in other order or simultaneously. Besides, it will be appreciated by those skilled in the art that the implementations described in the specification are exemplary implementations and the actions and modules involved are not necessarily essential to the disclosure.

In the foregoing implementations, the description of each implementation has its own emphasis. For the parts not described in detail in one implementation, reference may be made to related descriptions in other implementations.

In the implementations of the disclosure, it should be understood that, the device/apparatus disclosed in implementations provided herein may be implemented in other manners. For example, the device/apparatus implementations described above are merely illustrative; for instance, the division of the unit is only a logical function division and there can be other manners of division during actual implementations, for example, multiple units or assemblies may be combined or may be integrated into another system, or some features may be ignored, omitted, or not performed. In addition, coupling or communication connection between each illustrated or discussed component may be direct coupling or communication connection, or may be indirect coupling or communication among devices or units via some interfaces, and may be electrical connection or other forms of connection.

The units described as separate components may or may not be physically separated, the components illustrated as units may or may not be physical units, that is, they may be in the same place or may be distributed to multiple network elements. All or part of the units may be selected according to actual needs to achieve the purpose of the technical solutions of the implementations.

In addition, the functional units in various implementations of the disclosure may be integrated into one processing unit, or each unit may be physically present, or two or more units may be integrated into one unit. The above-mentioned integrated unit can be implemented in the form of hardware or a software function unit.

The integrated unit may be stored in a computer-readable memory when it is implemented in the form of a software functional unit and is sold or used as a separate product. Based on such understanding, the technical solutions of the disclosure essentially, or the part of the technical solutions that contributes to the related art, or all or part of the technical solutions, may be embodied in the form of a software product. The software product is stored in a memory and includes instructions for causing a computer device (which may be a personal computer, a server, or a network device and so on) to perform all or part of the operations of the method of the various implementations of the disclosure. The memory may include various medium capable of storing program codes, such as a universal serial bus (USB), a read-only memory (ROM), a random access memory (RAM), a removable hard disk, Disk, compact disc (CD), etc.

It will be understood by those of ordinary skill in the art that all or part of the operations of the method of the foregoing implementations may be accomplished by means of programs to instruct associated hardware. The programs may be stored in a computer-readable memory. The memory may include a flash memory, an ROM, an RAM, Disk or CD, etc.

The implementations of the disclosure have been described in detail. While the principles and implementations of the disclosure have been depicted in connection with illustrative implementations, it is to be understood that the foregoing implementations are only used to help understand the method and core idea of the disclosure. For those skilled in the art, according to the idea of the disclosure, there will be changes in specific implementations and application scope. Therefore, the disclosure is not to be limited to the disclosed implementations.

1. A system for device control, comprising a power supply, a controller, at least one load-power distribution module, and a plurality of loads corresponding to each of the at least one load-power distribution module, wherein
the power supply is configured for powering;
the controller is configured to generate a control signal; and
the at least one load-power distribution module is configured to receive the control signal to control a plurality of loads of a load-power distribution module corresponding to the control signal to work, and a power of each of the plurality of loads is less than or equal to a total output power of the power supply.

2. The system of claim 1, wherein the control signal is configured to control a target load-power distribution module, and the target load-power distribution module is any of the at least one load-power distribution module; and
the target load-power distribution module is configured to control a plurality of loads corresponding to the target load-power distribution module to work simultaneously, in response to the control signal.

3. The system of claim 1, wherein the at least one load-power distribution module configured to receive the control signal to control the plurality of loads of the load-power distribution module corresponding to the control signal to work is specifically configured to:
control a load-power distribution module i to stop working when the load-power distribution module i controls, for a preset duration, a load corresponding the load-power distribution module i to work, wherein the load-power distribution module i is one of the at least one load-power distribution module;
determine a next load-power distribution module of the load-power distribution module i; and
control, with the next load-power distribution module, a plurality of loads corresponding to the next load-power distribution module to work simultaneously.

4. The system of claim 3, wherein the load-power distribution module i comprises a timer, the timer is configured to set the preset duration.

5. The system of claim 1, wherein the controller is connected with the plurality of loads;
the controller is configured to obtain state parameters of the plurality of loads, and generate the control signal according to the state parameters.

6. A method for device control, applied to a system for device control comprising a power supply for powering, a controller, at least one load-power distribution module, and a plurality of loads corresponding to each of the at least one load-power distribution module, the method comprising:
generating, with the controller, a control signal; and
controlling, with a load-power distribution module corresponding to the control signal, a plurality of loads of the load-power distribution module corresponding to the control signal to work in response to the control signal, a power of each of the plurality of loads being less than or equal to a total output power of the power supply.

7. The method of claim 6, wherein
the control signal is configured to control a target load-power distribution module, and the target load-power distribution module is any of the at least one load-power distribution module; and
controlling the plurality of loads of the load-power distribution module corresponding to the control signal to work comprises:
controlling a plurality of loads corresponding to the target load-power distribution module to work simultaneously.

8. The method of claim 6, wherein controlling the plurality of loads of the load-power distribution module corresponding to the control signal to work comprises:
controlling a load-power distribution module i to stop working when the load-power distribution module i controls, for a preset duration, a load corresponding the load-power distribution module i to work, wherein the load-power distribution module i is one of the at least one load-power distribution module;
determining a next load-power distribution module of the load-power distribution module i; and
controlling, with the next load-power distribution module, a plurality of loads corresponding to the next load-power distribution module to work simultaneously.

9. A control device, comprising:
a processor; and
a memory, coupled with the processor, and storing computer programs which are operable with the processor to execute the operations of the method of claim 6.

10. A non-transitory computer-readable storage medium storing computer programs which, when executed by a processor, cause the processor to carry out actions, comprising:
generating a control signal; and
controlling a plurality of loads of a load-power distribution module corresponding to the control signal to work in response to the control signal, a power of each of the plurality of loads being less than or equal to a total output power of a power supply, a system for device control comprising at least one load-power distribution module, a plurality of loads corresponding to each of the at least one load-power distribution module, and the power supply.

11. The system of claim 1, wherein the load-power distribution module is connected in parallel with a plurality of loads corresponding to the load-power distribution module.

12. The method of claim 8, wherein the preset duration is set with a timer of the load-power distribution module i.

13. The method of claim 6, further comprising:
obtaining, with the controller, state parameters of the plurality of loads, wherein the controller is connected with the plurality of loads;
generating the control signal comprising:
generating the control signal according to the state parameters.

14. The method of claim 6, wherein the load-power distribution module is connected in parallel with a plurality of loads corresponding to the load-power distribution module.

15. The non-transitory computer-readable storage medium of claim 10, wherein the computer programs executed by the processor to carry out the action of controlling the plurality of loads of the load-power distribution module corresponding to the control signal to work are executed by the processor to carry out actions, comprising:
controlling a plurality of loads corresponding to a target load-power distribution module to work simultaneously, wherein the control signal is configured to control the target load-power distribution module, and the target load-power distribution module is any of the at least one load-power distribution module.

16. The non-transitory computer-readable storage medium of claim 10, wherein the computer programs executed by the processor to carry out the action of controlling the plurality of loads of the load-power distribution module corresponding to the control signal to work are executed by the processor to carry out actions, comprising:
controlling a load-power distribution module i to stop working when the load-power distribution module i controls, for a preset duration, a load corresponding the load-power distribution module i to work, wherein the load-power distribution module i is one of the at least one load-power distribution module;
determining a next load-power distribution module of the load-power distribution module i; and
controlling, with the next load-power distribution module, a plurality of loads corresponding to the next load-power distribution module to work simultaneously.

17. The non-transitory computer-readable storage medium of claim 16, wherein the preset duration is set with a timer of the load-power distribution module i.

18. The non-transitory computer-readable storage medium of claim 10, wherein
the computer programs are further executed by the processor to carry out actions, comprising:
obtaining state parameters of the plurality of loads.
the computer programs executed by the processor to carry out the action of generating the control signal are executed by the processor to carry out actions, comprising:
generating the control signal according to the state parameters.

19. The non-transitory computer-readable storage medium of claim 10, wherein the load-power distribution module is connected in parallel with a plurality of loads corresponding to the load-power distribution module.
